(19) United States
(12) Patent Application Publication
(10) Pub. No.: US 2006/0141847 A1
(43) Pub. Date: Jun. 29, 2006

(54) Indexable electrical connector alignment system

(76) Inventor: Hung Viet Ngo, Harrisburg, PA (US)

Correspondence Address: WOODCOCK WASHBURN, LLP, ONE LIBERTY PLACE - 46TH FLOOR, PHILADELPHIA, PA, 19103, US

(21) Appl. No.: 11/022,138

(22) Filed: Dec. 23, 2004

(51) Int. Cl. H01R 13/64

(52) U.S. Cl. 439/378

(57) ABSTRACT

Indexable electrical connector alignment systems for backplane, coplanar, etc., connections are disclosed. The alignment systems include indexable pin and socket modules. A pin is removably received in a pin module and can be removed, rotated, and re-secured in the pin module to correspond to a socket orientation. A socket likewise is removably received in a socket module and can be removed, rotated, and re-secured to correspond to a pin orientation. The socket and pin modules disclosed may additionally have the same substrate footprint such that a substrate disposed to receive a socket module can alternatively receive a pin module, and vice versa.

### FIELD OF THE INVENTION

The invention relates generally to electrical connectors. More specifically, the invention relates to alignment systems for right angle and co-planar connections.

### BACKGROUND OF THE INVENTION

Connector alignment systems may be included with, for example, daughter cards and extended cards to ensure proper alignment of such cards when making, for example, coplanar or backplane connections. The alignment system may help prevent unanticipated or incorrect connections and damage to cards, motherboards, and electrical connectors associated with the cards and mother boards. The typical alignment system includes, for example, one or more pins in a housing attached to a printed circuit board (PCB). The pins may be inserted into respective sockets located on another PCB. Alternatively, a motherboard may include alignment pins protruding through it for insertion into respective sockets located on, for example, a daughter card.

The pins may be oriented to pre-align, for example, a daughter card and an extended card or a daughter card and a motherboard before electrical connection is initiated. Additionally, the pins and sockets may be pre-configured to ensure, for example, that a daughter card intended for connection with a motherboard in a certain area is not mistakenly connected to the motherboard in another area. Such alignment may be assured by, for example, shaping the pin and the opening in the socket such that the pin may be properly inserted into the socket only if the pin is in proper alignment with the socket opening.

There are many problems associated with such alignment systems. First, a user may be required to maintain a large inventory of different pins and sockets to ensure that cards are not incorrectly connected with other cards or with a motherboard. For example, if eight different daughter cards are intended for electrical connection with a motherboard, then as many as eight different sets of alignment sockets may be required to ensure that none of the eight daughter cards is inserted into a wrong location on the motherboard.

A second problem with the alignment systems relates to the physical attachment of a housing of a pin or of a socket to a PCB. Such a housing may be securely attached to a PCB by forcing housing posts through respective preformed holes in the PCB. This connection process may expand the PCB's preformed holes while ensuring that the housing is held securely. If a user attaches, for example, the wrong socket housing to the PCB (i.e., a socket housing having a socket that is not in proper alignment with a corresponding pin), then the user must pull the socket housing out of the PCB and attach a different socket housing. The PCB holes, however, may not firmly hold the correct socket housing because the holes may have been enlarged by the insertion and removal of the posts of the incorrect socket housing.

Another problem associated with alignment systems is that footprints of the respective housings for a socket and a pin may be different, thus requiring different placement of the preformed PCB holes that receive the housing posts. For example, if a user intends to connect an extended card to a daughter card, the user must know whether the alignment system on the daughter card has a socket or a pin. Only then can the user know where to form the PCB holes for attachment of the corresponding alignment system element on the extended card.

Therefore, there is a need for an alignment system that reduces inventory requirements of users, that allows the firm attachment of alignment system housings to PCBs even after an incorrect alignment system housing has been attached to the PCB, and that addresses problems associated with different footprints of socket and pin housings.

### SUMMARY OF THE INVENTION

The invention provides an indexable alignment system for facilitating, for example, co-planar or backplane connections of daughter cards, extended cards, etc. The invention includes alignment system modules having indexable alignment elements that may be selectably positioned for proper alignment with corresponding elements of other alignment modules. Such elements include alignment pins and sockets. For example, an alignment pin protruding from a pin module may be configured in one of a plurality (e.g., 6, 8, 10, etc.) of selectable configurations. In the event that the pin module configuration does not correspond to the configuration of a corresponding socket module, the pin may be removed from the pin module, re-positioned to correspond to the receiving socket module, and re-secured in the module, thus obviating the desirability of maintaining an inventory of pin modules with varying orientations.

Additionally, the invention may preclude, for example, the desirability of removing a socket module from a printed circuit board or other substrate in the event that the module is misaligned with a corresponding pin module. Instead, the alignment element (i.e., a socket insert) may be removed from the socket module, indexed to a position corresponding to the configuration of the pin module, and re-secured.

The alignment modules additionally may have the same substrate footprint such that preformed holes made in the substrate for receiving an alignment module may receive either a socket or a pin module. In this way, for example, if an extended card will be connected to a daughter card, then the user may prepare the alignment holes on the extended card without learning whether the alignment modules on the daughter card are pin or socket modules.

### BRIEF DESCRIPTION OF THE DRAWINGS

FIG. 1 depicts example embodiments of alignment systems used in co-planar and backplane connections according to the invention.

FIGS. 2A and 2B depict, respectively, a side view and a perspective view of an example alignment system that may be used in a coplanar connection according to the invention.

FIG. 3 depicts an exploded, perspective view of an example pin module according to the invention.

FIGS. 4A and 4B depict, respectively, an exploded perspective view and a perspective view of an alternative embodiment of a pin module according to the invention.

FIGS. 5A and 5B depict, respectively, an exploded view of an example socket module and an example socket insert according to the invention.

### DETAILED DESCRIPTION OF ILLUSTRATIVE EMBODIMENTS

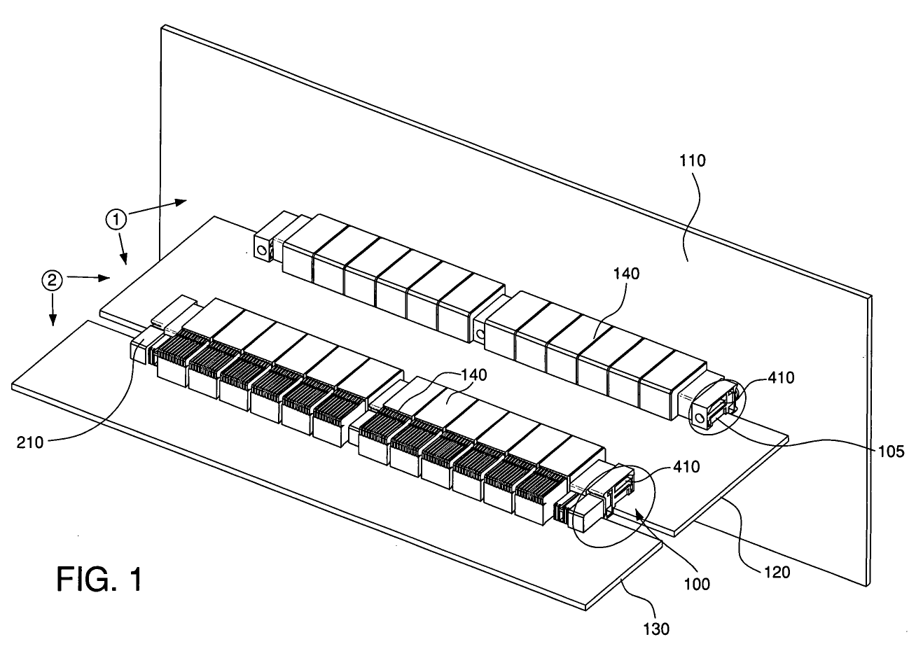

FIG. 1 depicts an example embodiment of an alignment system 100 used in coplanar connections 2 and an example embodiment of an alignment system 105 used in backplane connections 1. The backplane connection 1 may connect a daughter card 120 to a motherboard 110. The coplanar connection 2 may connect an extended card 130 to the daughter card 120. More specifically, electrical connectors 140 located on, for example, the extended card 130 may be electrically connected to respective electrical connectors 140 on the daughter card 120. The electrical connectors 140 may be right-angle connectors. Additionally, electrical connectors 140 on the daughter card 120 may be electrically connected to the motherboard 110.

The alignment system 100 may include a pin module 210 and a socket module 410 for use in the coplanar connection 2. The alignment system 105 may be used in the backplane connection 1 and may include the socket module 410 on the daughter card 120 physically connecting pins (not shown) protruding through or otherwise attached to the motherboard 110 (e.g., ensuring proper alignment and connection in the backplane connection may not include a pin module 210 such as used in the coplanar application). Of course, it will be recognized that the alignment systems disclosed herein may be used in many applications, including those where alignment of electrical connectors, printed circuit boards (PCBs), printed wiring boards (PWBs), or other substrates may be desired.

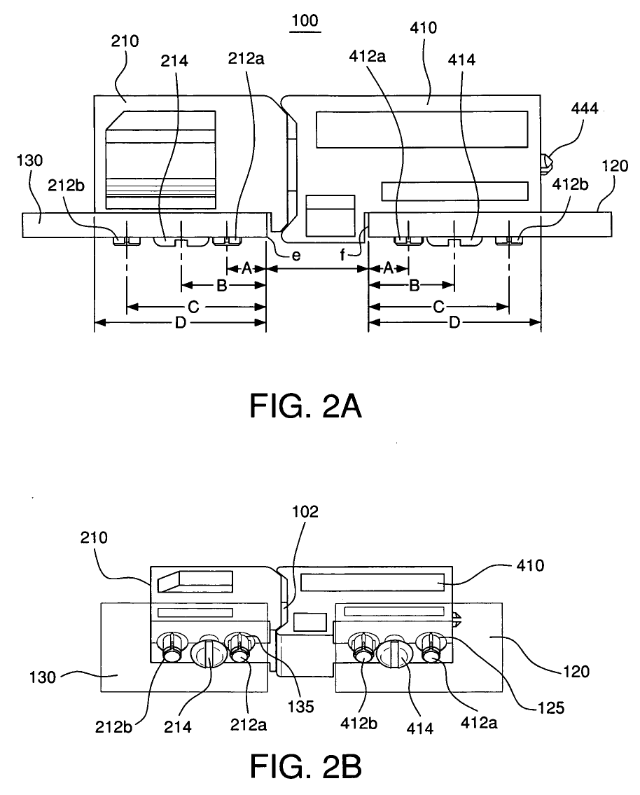

FIGS. 2A and 2B depict, respectively, a side view and a perspective view of the alignment system 100 that may be used in the coplanar connection 2. Retaining posts 212a, 212b on the pin module 210 may be inserted through preformed holes 135 located in the extended card 130. An assembly screw 214 may protrude through the extended card 130 and be secured in a corresponding threaded aperture (not shown) in the pin module 210. In this way, the assembly screw 214 may be tightened to maintain, in conjunction with the retaining posts 212a, 212b, the position of the pin module 210 on the extended card 130. Likewise, retaining posts 412a, 412b on the socket module 410 may be inserted through corresponding preformed holes 125 in the daughter card 120, and an assembly screw 414 may protrude through the daughter card 120 and be tightened in a corresponding threaded aperture in the socket module 410. Of course, it should be recognized that other mechanisms may be used to secure the pin module 210 and the socket module 410 on respective substrates.

The pin module 210 and the socket module 410 may be formed such that preformed holes in a PCB for receiving the pin module 210 may be used to receive the socket module 410 and vice versa. For example, the retaining posts 212a, 212b, 412a, 412b may have equal diameters and may be located such that the preformed holes 135, 125 in, respectively, the extended card 130 and the daughter card 120 are located an equal distance from respective edges e, f of the extended card 130 and the daughter card 120. With regard to the pin module 210, the retaining post 212a may be located a distance A from the edge e of the extended card 130. Likewise, with regard to the socket module 410, the retaining post 412a may be located the distance A from the edge f of the daughter card 120. The retaining posts 212b, 412b may be located a distance C, respectively, from the edges e, f of the extended card 130 and the daughter card 120. The assembly screws 214, 414 may be located a distance B, respectively, from the edges e, f of the extended card 130 and the daughter card 120. Finally, the length of the pin module 210 abutting the extended card 130 may be a distance D, as may the length of the socket module 410 abutting the daughter card 120. In sum, a footprint of the portion of the pin module 210 abutting the extended card 130 may be the same as a footprint of a portion of the socket module 410 abutting the daughter card 120.

The pin module 210 may be attached to either the extended card 130 or the daughter card 120, and likewise, the socket module 410 may be attached to either the daughter card 120 or the extended card 130. In this way, for example, a user preparing the extended card 130 for connection with the daughter card 120 may not need to know whether the pin module 210 or the socket module 410 is or will be attached to the daughter card 120 before forming the holes 135 for receiving the appropriate part of the alignment system 100. Instead, the user may pre-form the holes 135 and attach the appropriate part of the alignment system 100 at a later time.

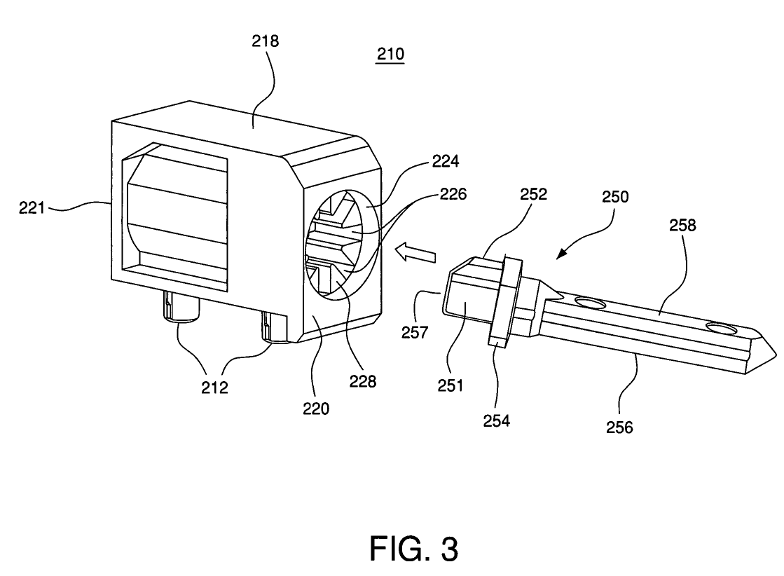

FIG. 3 depicts an exploded, perspective view of an example pin module 210 in accordance with the invention. The pin module 210 may include a pin housing 218 and a pin 250. The pin housing 218 may be a metal die cast body and may include the retaining posts 212, and a front face 220. A pin receiving aperture 224 may be formed through the front face 220 for receiving a tail end 251 of the pin 250. The pin receiving aperture 224 may include key slots 226 that may correspond to a key 252 on the tail end 251 of the pin 250. The key slots 226 may be, for example, spaced evenly around a circumference of the pin receiving aperture 224. For example, the key slots 226 may be spaced every 45° around the circumference of the pin receiving aperture 224, thereby providing eight key slots.

The pin 250 may include the tail end 251, the key 252, a shoulder 254, and a guide pin portion 256. The guide pin portion 256 may be disposed for insertion into the socket module 410. The guide pin portion 256 may include a flat surface 258 extending longitudinally along the guide pin portion 256 and may otherwise be round. The position or orientation of the pin 250 (e.g., the flat surface 258) may correspond to an aperture in the socket module 410. That is, the socket module 410 may include an aperture of a shape corresponding to the shape of the guide pin portion 256 such that, when the guide pin portion 256 is in a certain position or orientation, it may be inserted into the socket module 410.

The key slots 226 may enable indexing of the pin 250. For example, if the key slots 226 are spaced every 45° around the circumference of the pin receiving aperture 224, then the flat surface 258 of the guide pin portion 256 may be placed in one of eight potential positions, that is, orientations. The position chosen for the guide pin portion 256 may depend on the orientation of the aperture in the corresponding socket module 410. When the orientation for the guide pin portion 256 is determined, the tail end 251 may be inserted into the pin receiving aperture 224 and the key 252 may be inserted into the appropriate key slot 226 until the shoulder 254 abuts a corresponding stop 228 in the pin receiving aperture 224. The pin 250 may be secured by a screw (not shown) inserted longitudinally through an end 221 of the pin housing 218 opposite the front face 220. The screw then may be inserted into a threaded aperture 257 that extends longitudinally in the pin 250. Alternatively, the tail end 251 of the pin 250 may include an extension (not shown) having external threads that protrudes through the end 221 of the pin housing 218 opposite the front face 220. A nut may then be used to secure the pin 250 in the pin housing 218.

In the event that the orientation of the pin 250 does not correspond with the aperture in the socket module 410, the alignment may be corrected without removing the pin module 210 from, for example, the extended card 130 or the daughter card 120. Instead, the screw or nut securing the pin 250 in the pin housing 218 may be loosened or removed, the position of the pin 250 may be adjusted by indexing the key 252 to another key slot 226 and inserting the key 252 into the selected key slot 226. The pin 250 may then be re-secured in the pin housing 218 using the screw or nut as described herein.

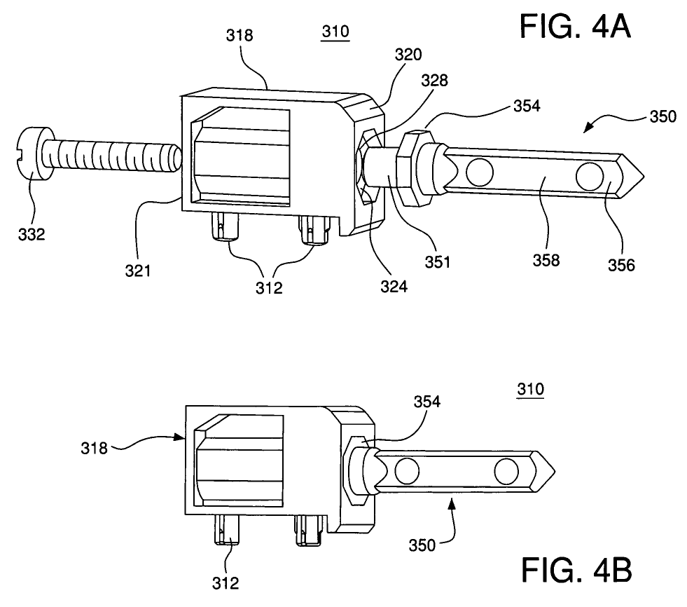

FIGS. 4A and 4B depict, respectively, an exploded perspective view and a perspective view of an alternative embodiment of a pin module 310 in accordance with the invention. The pin module 310 may include a pin housing 318 and a pin 350. The pin housing 318 may be a metal die cast body and may include retaining posts 312 and a front face 320. A pin receiving aperture 324 may be formed through the front face 320 for receiving a tail end 351 of the pin 350. The pin receiving aperture 324 may be an octagon shape that may correspond to an octagon-shaped shoulder 354 disposed on the pin 350. Of course, the pin receiving aperture 324 and the shoulder 354 may be other shapes (e.g., circular, other polygon shapes) and the octagonal shape is shown for example purposes only.

The pin 350 may include the tail end 351, the shoulder 354, and a guide pin portion 356. The guide pin portion 356 may be disposed for insertion into the socket module 410. The guide pin portion 356 may include a flat surface 358 extending longitudinally along the guide pin portion 356 and may otherwise be round. The position, that is, orientation, of the pin 350 (e.g., the flat surface 358) may correspond to an aperture in the socket module 410. That is, the socket module 410 may include an aperture of a shape to allow the guide pin portion 356 to be inserted into the socket module 410 if the flat surface 358 is in a corresponding position.

The configuration of the pin receiving aperture 324 in the shape of an octagon may enable the pin housing 318 to have a lower profile while continuing to enable adjustable indexing of the pin. This may enable the pin module 310 to be constructed with a lower profile than low-profile electrical connectors 140 (FIG. 1), facilitating, for example, cooling air flow to reach the connectors 140 without being inhibited by the pin modules 310.

The octagon-shaped pin receiving aperture 324 and the octagon-shaped shoulder 354 on the pin 350 may enable indexing of the pin 350. For example, the flat surface 358 of the guide pin portion 356 may be placed in one of eight potential positions. The position (e.g., orientation) chosen for the guide pin portion 356 may depend on the orientation of the aperture in the corresponding socket module 410. When the orientation for the guide pin portion 356 is determined, the tail end 252 may be inserted into the pin receiving aperture 324 and the shoulder 354 (and the pin 350) may be rotatably positioned and then inserted into the pin receiving aperture 324 until it abuts a corresponding stop 328. The pin 350 may be secured by a screw 332 inserted longitudinally through an end 321 of the pin housing 318 opposite the front face 320 and into a threaded aperture (not shown) extending longitudinally in the pin 350. Alternatively, the tail end 351 of the pin 350 may include an extension (not shown) having external threads that protrudes through the end 321 of the pin housing 318 opposite the front face 320. A nut may then be used on the extension to secure the pin 350 in the pin housing 318.

In the event that the orientation of the pin 350 does not correspond with the aperture in the socket module 410, the alignment may be corrected without removing the pin module 310 from, for example, the extended card 130, daughter card 120, or other substrate. Instead, the screw or nut securing the pin 350 in the pin housing 318 may be loosened or removed, the pin may be partially removed from the pin housing 318, and may be indexed or placed in a more appropriate position. The pin 350 may then be reinserted and re-secured in the pin housing 318.

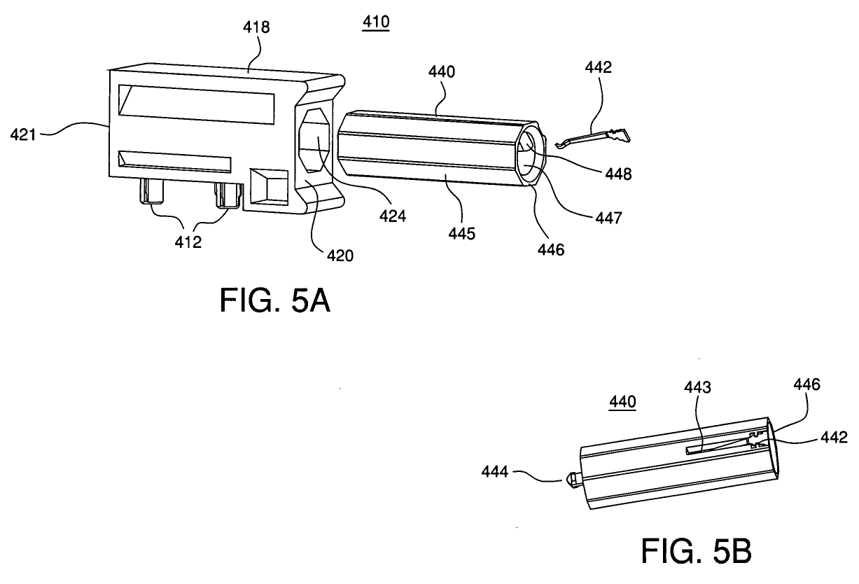

FIGS. 5A and 5B depict, respectively, an exploded perspective view of an example socket module 410 and a perspective view of an example socket insert 440 according to the invention. The socket module 410 may include a socket housing 418, the socket insert 440, and an electrostatic discharge (ESD) clip 442. The socket housing 418 may be a metal die cast body and may include the retaining posts 412 and a front face 420. A socket insert receiving aperture 424 may be formed through the front face 420 and may extend into the socket housing 418 for receiving the socket insert 440. The housing 418 may have a length D (FIG. 2) to provide a capability to receive the entire socket insert 440. The socket insert receiving aperture 424 may be an octagon shape that may correspond to an octagon shape of an exterior wall of the socket insert 440. Of course, the socket insert receiving aperture 424 and the exterior wall 445 of the socket insert 440 may be other shapes (e.g., circular, other polygon shapes) and the octagonal shape is shown for example purposes only.

The socket insert 440 may be plastic and may include a pin receiving aperture 446 that may extend into the socket insert 440 and may be disposed to receive a guide pin portion such as the guide pin portion 256 of the pin 250. The shape of the pin receiving aperture 446 may be defined by an interior wall 447 of the socket insert 440 and may include a flat portion 448 corresponding, for example, to the flat surface 258 of the guide pin portion 256 of the pin 250. An ESD clip aperture 443 may be disposed on the socket insert 440 and may receive the ESD clip 442. The ESD clip 442 may be attached to the exterior wall 445 of the socket insert 440 and may extend into the socket insert 440 through the ESD aperture 443 such that it may contact a pin such as the pin 250 when inserted into the socket module 410. The ESD clip 442 may also contact the socket housing 418. In this way, the ESD clip 442 may provide a grounding electrical connection between the pin 250 and the socket housing 418 which may discharge a static electrical charge that may be created, for example during insertion of the pin 250 into the socket module 410. Additionally, the ESD clip 442 may be disposed on the flat portion 448 of the socket insert 440 and therefore may contact with a flat portion of a pin such as the flat surface 258 of the guide pin portion 256 of the pin 250.

The socket insert 440 may also include an assembly latch 444 that may be inserted into a corresponding aperture (not shown) located in an end 421 of the socket housing opposite the front face 420. The assembly latch 444 may secure the socket insert 440 in the socket housing 418. This may best be depicted in FIG. 2A.

The socket insert 440 may be octagon shaped which may correspond with the octagon shape of the socket insert receiving aperture 424. The octagon-shaped socket insert 440 and the socket insert receiving aperture 424 may enable indexing the socket insert 440. For example, the flat surface 448 of the socket insert 440 may be placed in one of eight potential positions, that is, orientations. The position chosen for the socket insert 440 may depend on the orientation of a pin such as the pin 250 that may be inserted into the socket module 410. When the orientation for the socket insert 440 is determined, the socket insert 440 may be inserted into the socket insert receiving aperture 424 until the assembly latch 444 is seated in the aperture (not shown) in the end 421 of the socket housing 418 opposite the front face 420.

In the event that the orientation of the flat surface 448 of the socket insert 440 does not correspond to a flat surface of a pin such as the flat surface 258 of the pin 250, the alignment may be corrected without removing the socket module 410 from, for example, the extended card 130 or the daughter card 120. Instead, the latch assembly 444 may be, for example, squeezed such that the socket insert 440 may be removed from the socket housing 418. The socket insert 440 may then be rotatably positioned consistent with the respective pin and reinserted into the socket housing 418. This indexing capability may be useful in the system 105 shown with regard to the backplane connection 1 (FIG. 1). The system 105 may not include a pin module such as the pin module 210, and may instead include alignment pins (not shown) attached directly to the motherboard 110. If the alignment pins in such applications are not readily indexable or rotatable, the socket module 410 may provide an indexing capability to align the socket module 410 with the respective pins in the motherboard 110 without removing the socket module 410 from a substrate.

Thus there have been described improved contact designs and methods suitable for right angle and coplanar connections. It is to be understood that the foregoing illustrative embodiments have been provided merely for the purpose of explanation and are in no way to be construed as limiting of the invention. For example, the shapes of the pin and socket housings and the respective pins may be other shapes to provide an indexing capability and in no way is the invention limited to keys, key slots, or octagonal configurations. Words which have been used herein are words of description and illustration, rather than words of limitation. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1-20. (canceled)

21. An alignment module for facilitating electrical connection of a printed circuit board, the alignment module comprising:
a housing adapted for attachment to the printed circuit board, wherein the housing comprises a plurality of key slots, wherein each key slot is disposed to receive a key of an alignment element in one of a plurality of selectable positions.

22. The alignment module of claim 21, further comprising:
the alignment element received in and removably attached to the housing.

23. The alignment module of claim 22, wherein the alignment element is an alignment pin.

24. An alignment module for facilitating electrical connection of a printed circuit board, the alignment module comprising:
a housing constructed of metal and adapted for attachment to the printed circuit board to receive an alignment element in one of a plurality of selectable positions, wherein the housing comprises an aperture disposed to receive at least a portion of the alignment element, and wherein the aperture comprises a shape that defines the selectable positions.

25. The alignment module of claim 24, wherein the shape of the aperture is a polygon and the aperture is disposed to receive a portion of an alignment pin, and wherein the alignment pin is the alignment element and the portion of the alignment pin is in a shape of the polygon.

26. The alignment module of claim 24, wherein the shape of the aperture is a polygon and the aperture is disposed to receive a socket insert,
wherein the socket insert is the alignment element and comprises an exterior wall and an interior wall,
wherein the exterior wall is in a shape of the polygon and the interior wall defines a shape of an interior of the socket insert,
wherein the interior of the socket insert is disposed to receive at least a portion of an alignment pin, and
wherein the interior wall of the socket insert comprises a flat surface extending longitudinally along a length of the interior of the socket insert.

27. The alignment module of claim 26, wherein the socket insert further comprises an electrostatic discharge clip disposed on the flat surface of the interior wall.

28. The alignment module of claim 24, wherein the alignment element is constructed of plastic.

29. The alignment module of claim 24, wherein the alignment element is constructed of metal.

30. An alignment system for facilitating electrical connection of a first printed circuit board to a second printed circuit board, the alignment system comprising:
a pin module adapted for attachment to the first printed circuit board and comprising an alignment pin removably attached in a pin housing, wherein a portion of the alignment pin protrudes from the pin housing; and
a socket module constructed of metal adapted for attachment to the second printed circuit board and comprising a socket insert removably attached in a socket housing, wherein the socket module is disposed to receive the portion of the alignment pin protruding from the pin housing.

31. The alignment system of claim 30, wherein a footprint of the pin module on the first printed circuit board is the same as a footprint of the socket module on the second printed circuit board.

32. The alignment system of claim 30, wherein the pin housing is disposed to receive and retain the alignment pin in one of a plurality of selectable positions.

33. The alignment system of claim 30, wherein the socket housing is disposed to receive and retain the socket insert in one of a plurality of selectable positions.

34. The alignment system of claim 33, wherein the socket housing comprises an aperture in a shape of a polygon,
wherein the aperture defines the selectable positions,
wherein the socket insert comprises an exterior wall and an interior wall,
wherein the exterior wall is in a shape of the polygon and the interior wall defines a shape of an interior of the socket insert,
wherein the interior of the socket insert is disposed to receive the portion of the alignment pin, and
wherein the interior wall of the socket insert comprises a flat surface extending longitudinally along a length of the interior of the socket insert.

35. The alignment system of claim 34, wherein the socket insert further comprises an electrostatic discharge clip disposed on the flat surface of the interior wall.

36. The alignment system of claim 30, wherein the alignment pin is constructed of plastic.

37. The alignment system of claim 30, wherein the alignment pin is constructed of metal.

38. The alignment system of claim 30, wherein the socket insert is constructed of plastic.

39. The alignment system of claim 30, wherein the socket insert is constructed of metal.

40. The alignment system of claim 30, wherein the pin housing comprises a plurality of key slots, each disposed to receive a key of the alignment pin in one of a plurality of selectable positions.
